(19) United States
(12) Patent Application Publication
(10) Pub. No.: US 2026/0088748 A1
(43) Pub. Date: Mar. 26, 2026

(54) DRIVE DEVICE

(71) Applicant: TOYOTA JIDOSHA KABUSHIKI KAISHA, Toyota-shi (JP)

(72) Inventors: Hiroaki TOYODA, Mishima-shi (JP); Hiroshi Morita, Susono-shi (JP); Kazuma Fujiwara, Kobe-shi (JP); Hiroshi Yaguchi, Susono-shi (JP)

(73) Assignee: TOYOTA JIDOSHA KABUSHIKI KAISHA, Toyota-shi (JP)

(21) Appl. No.: 19/185,450

(22) Filed: Apr. 22, 2025

(30) Foreign Application Priority Data
Sep. 25, 2024 (JP) 2024-166395

(51) Int. Cl. H02P 25/22; B60L 15/00

(52) U.S. Cl. CPC H02P 25/22; B60L 15/007

(57) ABSTRACT

The drive device includes a power storage device, a motor having a three-phase open winding, a first inverter unit connected to the power line to which the power storage device is connected and connected to one end side of the three-phase open winding, a second inverter unit connected to the opposite side of the power storage device with respect to the first inverter in the power line and connected to the other end side of the three-phase open winding, a first, provided between the second inverter unit, H drive for driving the motor by the first and second inverter unit, and a changeover switch for switching the second inverter unit side from the motor to the neutral point and the Y drive for driving the motor by the first inverter unit. The first inverter unit includes a three-level inverter.

### CROSS-REFERENCE TO RELATED APPLICATION

This application claims priority to Japanese Patent Application No. 2024-166395 filed on September 25, 2024. The disclosure of the above-identified application, including the specification, drawings, and claims, is incorporated by reference herein in its entirety.

### BACKGROUND

### 1. Technical Field

The present disclosure relates to a drive device.

### 2. Description of Related Art

Conventionally, there has been proposed a drive device including a power storage device, a motor having a three-phase open winding, a first inverter unit that is connected to a power line to which the power storage device is connected and that is also connected to one end side of the three-phase open winding, a second inverter unit that is connected a portion of the power line on an opposite side of a first inverter from the power storage device and that is also connected to another end side of the three-phase open winding, and a changeover switch that is provided on the power line between first and second inverters (e.g., see Japanese Unexamined Patent Application Publication No. 2018-14829 (JP 2018-14829 A)). In such a drive device, driving is executed by switching between Δ driving (H driving) and Y driving. Δ driving (H driving) is driving in which the motor is driven by the first and second inverter units with the changeover switch in an on state. Y driving is driving in which the other end side of the three-phase open winding is made to form a neutral point by the second inverter, and the motor is driven by the first inverter unit, with the changeover switch in an off state.

### SUMMARY

In the above-described drive device, a maximum value of applied voltage of each phase of the motor is substantially equal to voltage of the power storage device during H driving, and the maximum value of the applied voltage of each phase of the motor is substantially equal to 1/2 of the voltage of the power storage device during Y driving. Accordingly, while core loss in the motor can be reduced in Y driving as compared to H driving, there is demand for further reduction of core loss in the motor.

The present disclosure provides a drive device that reduces core loss of a motor.

In order to achieve the above primary object, the drive device according to the present disclosure adopts the following measures.

The gist of the present disclosure is a drive device that includes a power storage device, a motor that includes an open winding of three phases, a first inverter unit that is connected to a power line to which the power storage device is connected, and that is also connected to one end side of the open winding of the three phases, a second inverter unit that is connected to a portion of the power line on an opposite side of the first inverter unit from the power storage device, and that is also connected to another end side of the open winding of the three phases, and a changeover switch that is provided between the first and second inverter units, and that is for switching between H driving in which the motor is driven by the first and second inverter units, and Y driving in which a side further toward the second inverter unit from the motor is made to form a neutral point, and also the motor is driven by the first inverter unit, in which the first inverter unit includes a three-level inverter.

In the drive device according to the present disclosure, the first inverter unit includes the three-level inverter. Thus, a two-level H drive mode can be executed, in which potentials on the one end side and the other end side of the open winding of the three phases are switched at two levels each by the first and second inverter units in H driving. Also, a two-level Y drive mode can be executed, in which potential at the one end side of the open winding of the three phases is switched at two levels each by the first inverter unit in Y driving. Further, a three-level Y drive mode can be executed, in which potential at the one end side of the open winding of the three phases is switched at three levels each by the first inverter unit in Y driving. Execution of such a three-level Y drive mode can further reduce core loss in the motor.

The drive device according to the present disclosure may further include a control device that executes, in order from a side of smaller torque and revolutions of the motor, a three-level Y drive mode in which potential at the one end side of the open winding of the three phases is switched at three levels each by the first inverter unit in the Y driving, a two-level Y drive mode in which potential at the one end side of the open winding of the three phases is switched at two levels each by the first inverter unit in the Y driving, and a two-level H drive mode in which potentials of the one end side and the other end side of the open winding of the three phases are switched at two levels each by the first and second inverter units in the H driving. Thus, core loss in the motor can be further reduced in a low-revolution low-torque side region of the motor.

In the drive device according to the present disclosure, the first inverter unit may include an upper arm and a lower arm of the three phases that are connected in series with each other with respect to a positive-side line and a negative-side line of the power line for each phase, and also of which mutual connection points are correspondingly connected to the one end side of the open winding, first and second capacitors that are connected in series with each other with respect to the positive-side line and the negative-side line, an intermediate potential line of the three phases that connects each of the connection points of the upper arm and the lower arm of the three phases and a connection point of the first and second capacitors, and an intermediate potential switch of the three phases that are each provided on the intermediate potential line of the three phases, and power capacity and breakdown voltage of the intermediate potential switch are lower than of the upper arm and the lower arm. Thus, costs of the intermediate potential switch can be reduced.

In the drive device according to the present disclosure, the changeover switch may be provided to a portion of the power line that is between the first and second inverter units.

In the drive device according to the present disclosure, the changeover switch may be provided between the open winding of the three phases and the second inverter unit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a drive device according to an embodiment of the present disclosure;

FIG. 2 is a schematic configuration diagram of a drive device;

FIG. 3 is an explanatory diagram illustrating an example of a state of a two-level H drive mode;

FIG. 4 is an explanatory diagram illustrating an example of a state of a two-level Y drive mode;

FIG. 5 is an explanatory diagram illustrating an exemplary execution-mode map; and

FIG. 6 is a schematic diagram of a drive device according to a modification.

### DETAILED DESCRIPTION OF EMBODIMENTS

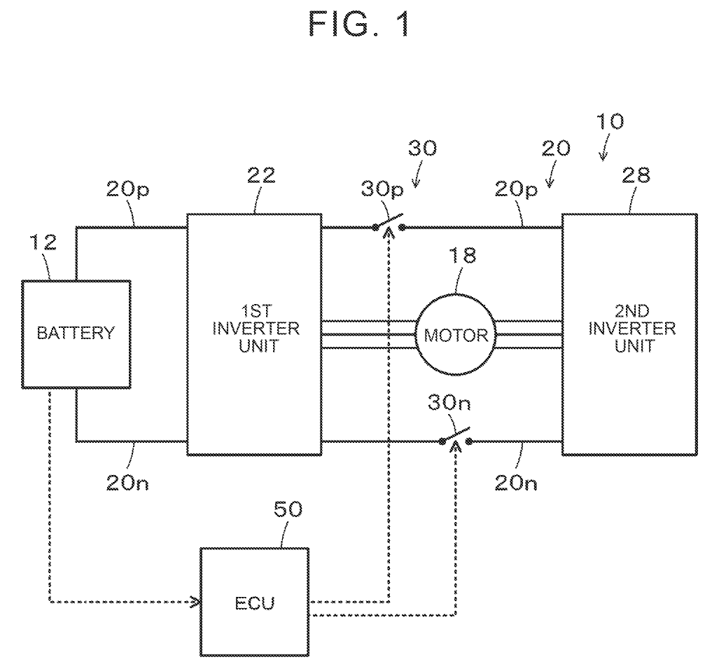

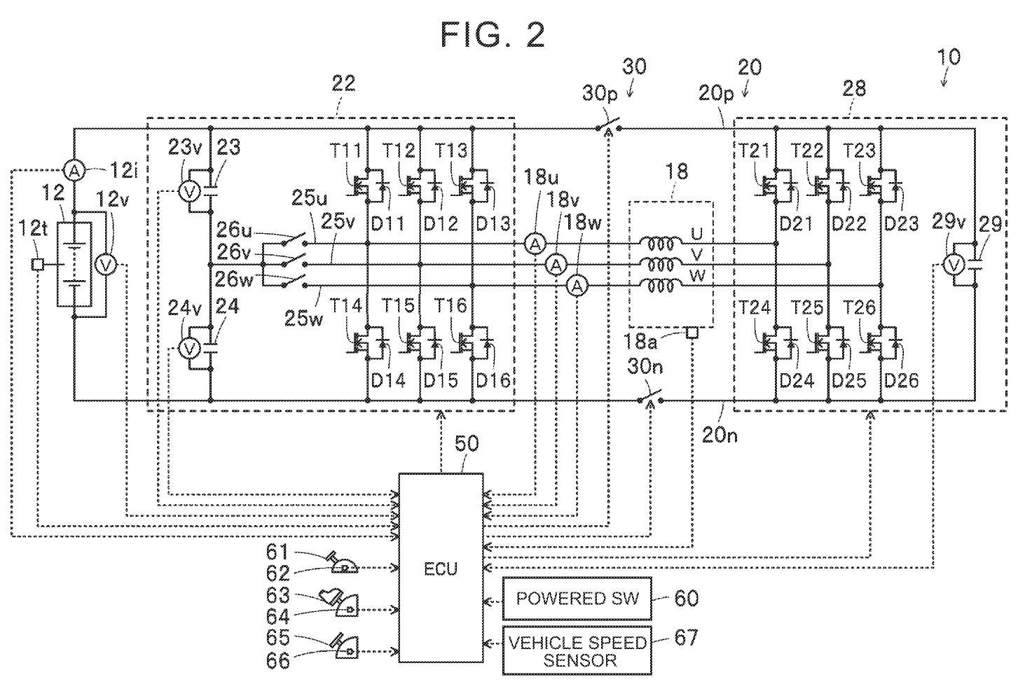

Embodiments for carrying out the present disclosure will be described with reference to the drawings. FIG. 1 is a schematic diagram schematically illustrating a drive device 10 according to an embodiment of the present disclosure. FIG. 2 is a schematic configuration diagram illustrating a schematic configuration of the drive device 10. As illustrated in FIGS. 1 and 2, the drive device 10 of the embodiment includes a battery 12 as a power storage device, a motor 18, a first inverter unit 22, a second inverter unit 28, a changeover switch 30, and an electronic control unit (hereinafter referred to as "ECU") 50 as a control device. The drive device 10 is mounted on a battery electric vehicle, a hybrid electric vehicle, fuel cell electric vehicle, or the like.

The battery 12 is configured as, for example, a lithium-ion secondary battery or a nickel-hydrogen secondary battery, and is connected to the power line 20 (the positive-side line 20p and the negative-side line 20n). The motor 18 is configured as a three-phase AC motor, and includes a rotor in which permanent magnets are embedded in a rotor core, and a stator in which coils (open windings) of three phases (U-phase, V-phase, and W-phase) are wound around the stator core. The rotor is connected to a drive shaft connected to the drive wheels via a differential gear.

The first inverter unit 22 is connected to the power line 20. The first inverter unit 22 includes a T-type three-level inverter. Specifically, the first inverter unit 22 includes six transistors T11 to T16, six diodes D11 to D16 connected in parallel to T16 from the six transistors T11, two capacitors 23 and 24, a three-phase (U-phase, V-phase, and W-phase) intermediate potential line 25u, 25v, 25w, and a three-phase intermediate potential switch 26u, 26v, 26w.

For the transistors T11 to T16, for example, MOSFET or IGBT is used. The transistors T11 to T16 are arranged two each in pairs so as to be on the source-side and the sink-side with respect to the positive-side line 20p and the negative-side line 20n, respectively. The connection point of the transistor T11, T14, the connection point of the transistor T12, T15, and the connection point of the transistor T13, T16 are connected to one end of the U-phase, V-phase, and W-phase coils of the motor 18, respectively. Hereinafter, T13 from the transistor T11 may be referred to as a "first upper arm", and T16 from the transistor T14 may be referred to as a "first lower arm".

The capacitors 23 and 24 are connected in series to the positive-side line 20p and the negative-side line 20n in this order. Capacitors 23 and 24, those of the same specifications are used with each other. Intermediate potential line 25u, 25v, 25w of three phases, the connection point of the transistor T11, 14, the connection point of the transistor T12, T15, and the connection point of the transistor T13, T16, and a connection point of the capacitor 23 and 24, respectively. The three-phase intermediate potential switch 26u, 26v, 26w are respectively provided in the three-phase intermediate potential lines 25u, 25v, 25w. As the three-phase intermediate potential switch 26u, 26v, 26w, for example, a semiconductor switch, specifically, a wide bandgap semiconductor switch using gallium nitride (GaN) or silicon carbide (SiC) is used. The intermediate potential switch 26u may be configured such that the diodes are connected in series so as to be opposite to each other, for example, using two sets of transistors and diodes connected in parallel thereto. The same applies to the intermediate potential switch 26v, 26w.

The second inverter unit 28 is connected to a side of the power line 20 opposite to the battery 12 with respect to the first inverter unit 22. The second inverter unit 28 includes a two-level inverter, and specifically includes six transistors T21 to T26, six diodes D21 to D26 connected in parallel to six T21 to T26, and a capacitor 29.

For the transistors T21 to T26, for example, MOSFET or IGBT is used. The transistors T21 to T26 are arranged two each in pairs so as to be on the source-side and the sink-side with respect to the positive-side line 20p and the negative-side line 20n, respectively. The connection point of the transistor T21, T24, the connection point of the transistor T22, T25, and the connection point of the transistor T23, T26 are connected to the other ends of the U-phase, V-phase, and W-phase coils of the motor 18, respectively. Hereinafter, T23 from the transistor T21 may be referred to as a "second upper arm", and T26 from the transistor T24 may be referred to as a "second lower arm". The capacitor 29 is connected to the positive-side line 20p and the negative-side line 20n.

The changeover switch 30 includes a positive-side switch 30p and a negative-side switch 30n. The positive-side switch 30p is provided between the first and second inverter units 22 and 28 of the positive-side line 20p. The negative-side switch 30n is provided between the first and second inverter units 22 and 28 of the negative-side line 20n. Each of the positive-side switch 30p and the negative-electrode-side switch 30n is, for example, a semi-conductor switch. The positive-side switch 30p may be configured by, for example, using two sets of transistors and diodes connected in parallel thereto, and being connected in series so that the diodes are opposite to each other. The same applies to the negative-side switch 30n.

ECU 50 includes a microcomputer having a CPU, ROM, RAM, a flash memory, an input/output port, and a communication port, various driving circuitry, and various logic IC. ECU 50 receives signals from various sensors. For example, ECU 50 receives the voltage Vb of the battery 12 from the voltage sensor 12v, the current Ib of the battery 12 from the current sensor 12i, and the temperature Tb of the battery 12 from the temperature sensor 12t. ECU 50 also receives the rotational position θm of the rotor of the motor 18 from the rotational position sensor 18a and the phase current Iu, Iv, Iw of each phase of the motor 18 from the current sensor 18u, 18v, 18w. ECU 50 also receives the voltage Vc1 of the capacitor 23 from the voltage sensor 23v, the voltage Vc2 of the capacitor 24 from the voltage sensor 24v, and the voltage Vc3 of the capacitor 29 from the voltage sensor 29v. ECU 50 also receives an on-off signal from the power switch 60, a shift position SP which is an operation position of the shift lever 61 from the shift position sensor 62, an accelerator operation amount Acc which is a depression amount of the accelerator pedal 63 from the accelerator pedal position sensor 64, a brake pedal position BP which is a depression amount of the brake pedal 65 from the brake pedal position sensor 66, and a vehicle speed V from the vehicle speed sensor 67.

Various control signals are outputted from ECU 50. For example, a control signal to the first inverter unit 22 (the intermediate potential switch 26u, 26v, 26w of T16 and the three phases from the transistor T11), a control signal to the second inverter unit 28 (the transistor T21 to T26), and a control signal to the changeover switch 30 (the positive-side switch 30p and the negative-side switch 30n) are outputted from ECU 50. ECU 50 calculates the power storage ratio SOC of the battery 12 based on the integrated value of the current Ib of the battery 12, and calculates the electric angle θe and the rotational speed Nm of the motor 18 based on the rotational position θm of the rotor of the motor 18.

In the drive device 10 of the embodiment, ECU 50 first sets a required torque Td* required for traveling based on the accelerator operation amount Acc and the vehicle speed V, and sets a torque command Tm* of the motor 18 so as to travel according to the set required torque Td*. Subsequently, the execution mode is set from the two-level H drive mode, the two-level Y drive mode, and the three-level Y drive mode based on the torque command Tm* and the rotational speed Nm of the motor 18, and the set execution mode is executed. Hereinafter, the two-level H drive mode, the two-level Y drive mode, and the three-level Y drive mode will be described, and a method of setting the execution mode will be described. Here, H driving means that the motor 18 is driven by the first and second inverter units 22 and 28, and Y driving means that the second inverter unit 28 side is made neutral and the motor 18 is driven by the first inverter unit 22 rather than the motor 18.

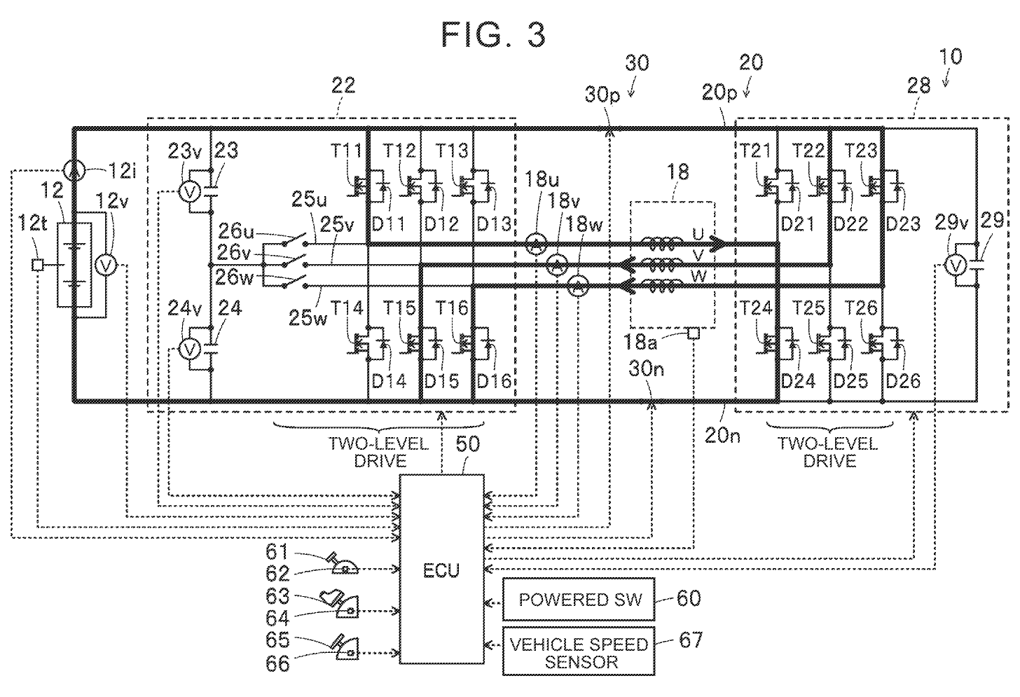

First, a two-level H drive mode will be described. FIG. 3 is an explanatory diagram illustrating an example of the state of the two-level H drive mode. As shown in the drawing, in the two-level H drive mode, the positive-side switch 30p and the negative-side switch 30n are turned on. Accordingly, the voltage Vb of the battery 12 is applied to the second inverter unit 28. Further, the first and second inverter units 22 and 28 turn off the three-phase intermediate potential switch 26u, 26v, 26w and switch-drive T26 from the transistor T11 to T16, T21. In this way, the potentials of one end side and the other end side of the coils of the respective phases of the motor 18 are switched at two levels (the potential of the positive-side line 20p and the potential of the negative-side line 20n). In FIG. 3, this is referred to as "two-level driving".

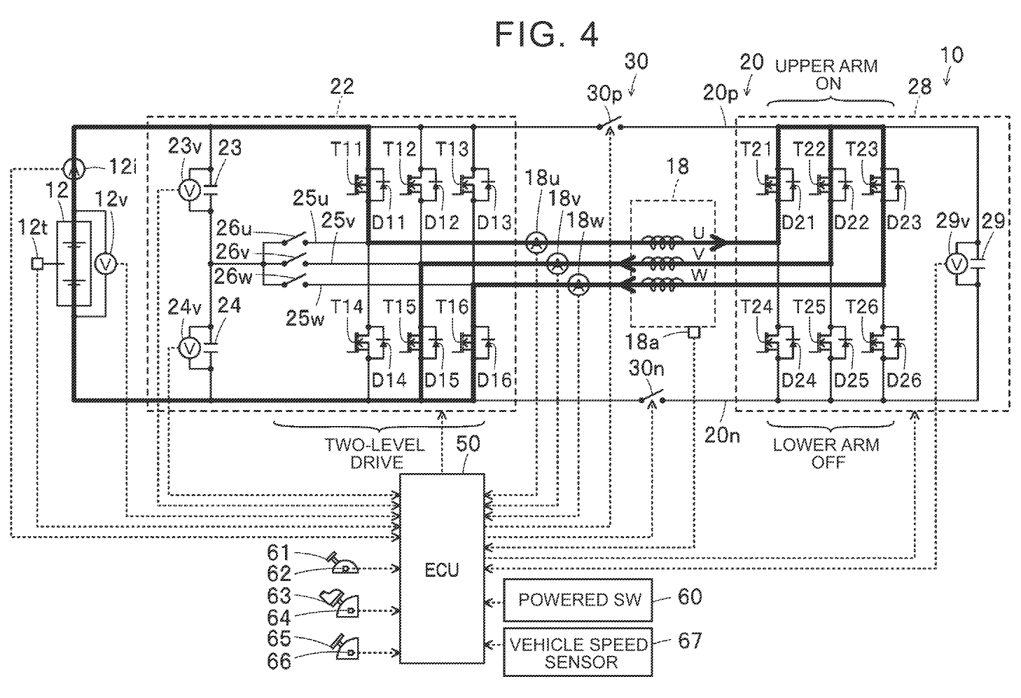

Next, the two-level Y drive mode will be described. FIG. 4 is an explanatory diagram illustrating an example of the state of the two-level Y drive mode. As illustrated, in the two-level Y drive mode, the positive-side switch 30p and the negative-side switch 30n are turned off. Accordingly, the voltage Vb of the battery 12 is not applied to the second inverter unit 28. Further, with respect to the second inverter unit 28, the second upper arm of three phases (from the transistor T21 to T23) is turned on and the third phase second lower arm (from the transistor T24 to T26) is turned off. In this way, the second inverter unit 28 side of the motor 18 is converted into a neutral point. Alternatively, the second upper arm of the three phases may be in the off state and the second lower arm of the three phases may be in the on state. Further, with respect to the first inverter unit 22, the three-phase intermediate potential switch 26u, 26v, 26w is turned off, and T16 is switched and driven from the transistor T11. In this way, the potential of one end side of the coil of each phase of the motor 18 is switched at two levels (the potential of the positive-side line 20p and the potential of the negative-side line 20n).

Further, the three-level Y drive mode will be described. In the three-level Y drive mode, T16 is switched from the three-phase intermediate potential switch 26u, 26v, 26w and the transistor T11 to the first inverter unit 22. In this respect, the three-level Y drive mode differs from the two-level Y drive mode in which the three-phase intermediate potential switch 26u, 26v, 26w is turned off and T16 is switched from the transistor T11. By the operation of the first inverter unit 22, the potential of one end side of the coil of each phase of the motor 18 is switched at three levels (the potential of the positive-side line 20p, the potential of the connection point of the capacitors 23 and 24, the potential of the negative-side line 20n).

As can be seen from FIG. 3, in the H drive (two-level H drive mode), the maximal value of the applied voltage of each phase of the motor 18 is substantially equal to the voltage Vb of the battery 12. On the other hand, as can be seen from FIG. 4, in the Y drive (two-level Y drive mode or three-level Y drive mode), the maximum value of the applied voltage of each phase of the motor 18 is approximately equal to 1/2 of the voltage Vb of the battery 12. Therefore, in the H drive, the applied voltage of the motor 18 can be made higher than in the Y drive. In other words, in the Y drive, the applied voltage of the motor 18 is lower than in the H drive. Thus, the core loss of the motor 18 can be reduced. In the Y drive (two-level Y drive mode or three-level Y drive mode), one of the second upper arm and the second lower arm of the three phases is turned on and the other is turned off for the second inverter unit 28. As a result, the switching loss of the second inverter unit 28 can be reduced as compared with the case of the H drive (two-level H drive mode) in which the second inverter unit 28 is switched and driven. Further, in the three-level Y drive mode, the voltages at one end of the coils of each phase of the motor 18 are switched at three levels. As a result, the ripple current of the motor 18 can be reduced and the core loss of the motor 18 can be further reduced as compared with the case of the two-level H drive mode or the two-level Y drive mode in which the voltages on one end side of the coils of the respective phases of the motor 18 are switched at two levels.

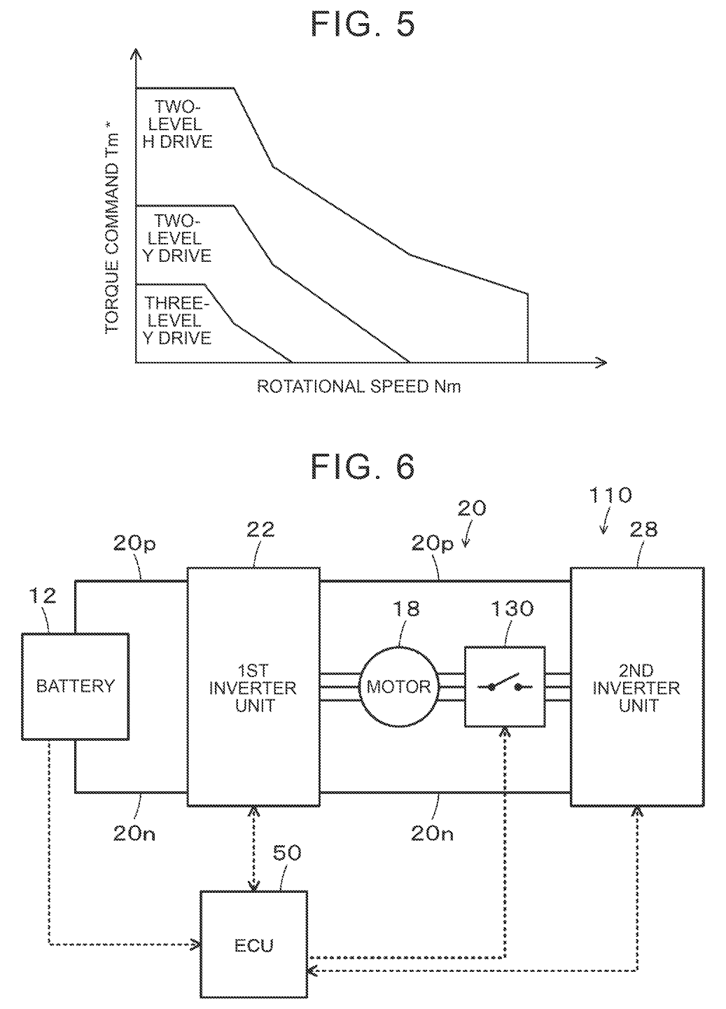

Next, a method of setting the execution mode will be described. In the embodiment, the execution mode is set from the two-level H drive mode, the two-level Y drive mode, and the three-level Y drive mode based on the torque command Tm* and the rotational speed Nm of the motor 18 and the execution mode map. FIG. 5 is an explanatory diagram illustrating an example of an execution mode map. The execution mode map is determined in advance by experimentation, analysis, or the like as a relation between the torque command Tm* and the rotational speed Nm of the motor 18 and the execution mode. As shown in the drawing, the execution mode is determined such that the torque command Tm* and the rotational speed Nm are smaller in the order of the three-level Y drive mode, the two-level Y drive mode, and the two-level H drive mode. The three-level Y drive mode among the three-level Y drive mode, the two-level Y drive mode, and the two-level H drive mode is set in the region on the lowest rotational speed low torque side. Accordingly, the ripple current of the motor 18 can be reduced in the region on the low rotational speed low torque side, and the core loss of the motor 18 can be further reduced. In addition, the power capacity and the breakdown voltage of the three-phase intermediate potential switch 26u, 26v, 26w that is switched and driven only in the three-level Y drive mode can be designed to be relatively low. Specifically, the power capacity and the breakdown voltage of the three-phase intermediate potential switch 26u, 26v, 26w can be designed to be lower than the power capacity and the breakdown voltage of T16 from the transistor T11 that is switched and driven in all modes. Consequently, the three-phase intermediate potential switch 26u, 26v, 26w can be reduced.

In the drive device mounted in the drive device 10 of the embodiment described above, the first inverter unit 22 includes a T-type three-level inverter. Thus, in addition to the two-level Y drive mode and the two-level H drive mode, the three-level Y drive mode can also be executed. Execution of the three-level Y drive mode can further reduce the core loss of the motor 18.

Further, in the drive device of the embodiment, the three-level Y drive mode, the two-level Y drive mode, and the two-level H drive mode are executed in order from the side where the torque command Tm* and the rotational speed Nm of the motor 18 are smaller. Thus, it is possible to further reduce the core loss of the motor 18 in the region of the low rotational speed low torque side. Further, the power capacity and the breakdown voltage of the three-phase intermediate potential switch 26u, 26v, 26w that is switched and driven only in the three-level Y drive mode can be designed to be lower than the power capacity and the breakdown voltage of T16 from the transistor T11 that is switched and driven in all modes. Consequently, the three-phase intermediate potential switch 26u, 26v, 26w can be reduced.

In the above-described embodiment, the three-level Y drive mode, the two-level Y drive mode, and the two-level H drive mode are executed in descending order of the torque command Tm* and the rotational speed Nm of the motor 18, but the present disclosure is not limited thereto. For example, the two-level Y drive mode, the three-level Y drive mode, and the two-level H drive mode may be executed in order from the side where the torque command Tm* and the rotational speed Nm of the motor 18 are smaller. In addition, the three-level Y drive mode and the two-level H drive mode may be executed in descending order of the torque command Tm* and the rotational speed Nm of the motor 18. Further, an outputting torque Tm may be used instead of the torque command Tm* of the motor 18. The output-torque Tm can, for example, coordinate-convert the phase current Iu, Iv, Iw of each phase into the current Id, Iq of the d-axis and the q-axis by using the electric angle θe (three-phase-two-phase conversion), and can be estimated based on the obtained current Id, Iq of the d-axis and the q-axis.

In the above-described embodiment, the power capacity and the breakdown voltage of the three-phase intermediate potential switch 26u, 26v, 26w are designed to be lower than the power capacity and the breakdown voltage of T16 from the transistor T11, but the present disclosure is not limited thereto. For example, the power capacity and the breakdown voltage of the three-phase intermediate potential switch 26u, 26v, 26w may be designed to be approximately equal to the power capacity and the breakdown voltage of the transistor T11 to T16.

In the above-described embodiment, the first inverter unit 22 includes a T-type three-level inverter, but may include a three-level inverter, for example, a neutral point clamp type three-level inverter.

In the above-described embodiment, the changeover switch 30 includes the positive-side switch 30p and the negative-side switch 30n, but may include only one of the positive-side switch 30p and the negative-side switch 30n.

In the above-described embodiment, the drive device 10 includes the changeover switch 30 (the positive-side switch 30p and the negative-side switch 30n). Alternatively, the drive device 10 may include a changeover switch 134 between the motor 18 and the second inverter unit 28, as illustrated in the drive device 110 of the modification of FIG. 6. The changeover switch 134 is configured to be able to switch between a neutral point state and a non-neutral point state. The neutral pointing state includes a plurality of switches, and neutralizes the second inverter unit 28 side of the motor 18. The non-neutral pointing state does not neutralize the second inverter unit 28 side of the motor 18. The changeover switch 134 is controlled by an ECU 50. In this case, in the Y drive, the motor 18 is driven by the first inverter unit 22 using the changeover switch 134 as a neutral point state. In the H drive, the motor 18 may be driven by the first and second inverter units 22 and 28 with the changeover switch 134 set to the non-neutral point state.

The correspondence between the main elements of the embodiments and the main elements of the disclosure described in the column of the means for solving the problem will be described. In the embodiment, the battery 12 corresponds to a "power storage device", and the motor 18 corresponds to a "motor". In the embodiment, the first inverter unit 22 corresponds to the "first inverter unit", the second inverter unit 28 corresponds to the "second inverter unit", and the changeover switch 30 corresponds to the "changeover switch". In the embodiment, the capacitors 23 and 24 correspond to the "first and second capacitors", and T13 and the transistor T14 to T16 correspond to the "three-phase upper arms and lower arms" from the transistor T11. In the embodiment, the three-phase intermediate potential line 25u, 25v, 25w corresponds to the "three-phase intermediate potential line", and the three-phase intermediate potential switch 26u, 26v, 26w corresponds to the "three-phase intermediate potential switch".

Note that the correspondence between the main elements of the embodiment and the main elements of the disclosure described in the section of the means for solving the problem is an example for specifically explaining the embodiment of the disclosure described in the section of the means for solving the problem, and therefore the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of a drive device and the like.

What is claimed is:

1. A drive device, comprising:
a power storage device;
a motor that includes an open winding of three phases;
a first inverter unit that is connected to a power line to which the power storage device is connected, and that is also connected to one end side of the open winding of the three phases;
a second inverter unit that is connected to a portion of the power line on an opposite side of the first inverter unit from the power storage device, and that is also connected to another end side of the open winding of the three phases; and
a changeover switch that is provided between the first and second inverter units, and that is for switching between H driving in which the motor is driven by the first and second inverter units, and Y driving in which a side further toward the second inverter unit from the motor is made to form a neutral point, and also the motor is driven by the first inverter unit, wherein
the first inverter unit includes a three-level inverter.

2. The drive device according to claim 1, further comprising a control device that executes, in order from a side of smaller torque and revolutions of the motor, a three-level Y drive mode in which potential at the one end side of the open winding of the three phases is switched at three levels each by the first inverter unit in the Y driving, a two-level Y drive mode in which potential at the one end side of the open winding of the three phases is switched at two levels each by the first inverter unit in the Y driving, and a two-level H drive mode in which potentials of the one end side and the other end side of the open winding of the three phases are switched at two levels each by the first and second inverter units in the H driving.

3. The drive device according to claim 2, wherein the first inverter unit includes
an upper arm and a lower arm of the three phases that are connected in series with each other with respect to a positive-side line and a negative-side line of the power line for each phase, and also of which mutual connection points are correspondingly connected to the one end side of the open winding, first and second capacitors that are connected in series with each other with respect to the positive-side line and the negative-side line, an intermediate potential line of the three phases that connects each of the connection points of the upper arm and the lower arm of the three phases and a connection point of the first and second capacitors, and an intermediate potential switch of the three phases that are each provided on the intermediate potential line of the three phases, and
power capacity and breakdown voltage of the intermediate potential switch are lower than of the upper arm and the lower arm.

4. The drive device according to claim 1, wherein the changeover switch is provided to a portion of the power line that is between the first and second inverter units.

5. The drive device according to claim 1, wherein the changeover switch is provided between the open winding of the three phases and the second inverter unit.
